(19) United States
(12) Patent Application Publication
(10) Pub. No.: US 2017/0262930 A1
(43) Pub. Date: Sep. 14, 2017

(54) System for Facilitating Common Purchases

(71) Applicant: DELL PRODUCTS, LP, Round Rock, TX (US)

(72) Inventors: Harsh N. Acharya, Round Rock, TX (US); Jeremy A. Reingold, Cedar Park, TX (US); Matthew D. Smith, Austin, TX (US); Campbell McNeill, Austin, TX (US)

(21) Appl. No.: 15/068,322

(22) Filed: Mar. 11, 2016

(51) Int. Cl. G06Q 30/06; G06Q 20/10

(52) U.S. Cl. CPC G06Q 30/0635; G06Q 20/102

(57) ABSTRACT

Embodiments herein disclose a system for enabling purchases spanning multiple categories of offerings in a common purchase made with the system. The system splits or separates a common purchase spanning multiple categories of offerings into purchase orders directed to individual categories of offerings and forwards the purchase orders to respective entities providing the offerings for fulfillment.

### FIELD OF THE DISCLOSURE

The present disclosure generally relates to information handling systems, and more particular relates to a system for facilitating common purchases.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system for providing offerings spanning different categories; and

FIG. 2 is a flow chart of a method for providing offerings spanning different categories.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Businesses sell different offerings such as products, services, and usage in different locations and with different systems. For example, a business may sell products with one virtual store, services with a different virtual store or portal, and usage with yet another different virtual store or portal. Using different locations and systems to sell different categories of offerings requires a customer engage with different business arms of a business to obtain products, services, and usages. This is cumbersome for a client or purchaser because the purchaser must navigate between different locations, such as different virtual portals or stores, to obtain a desired complement of products, services, and usage.

This cumbersomeness is reflected in a purchaser having to maintain multiple accounts and make multiple distinct purchasings for a group of related products, services, and usages. For example, a purchaser may have to maintain an account to purchase computers from a business, a different account to purchase services, such as Information Technology (IT), for the computers, and yet a different account with regard to usage of resources, such as cloud-based storage, for the computers. The purchaser may have to use different locations (which may be virtual) and systems to make the purchase of offerings from different categories. This disjoint between point of sale for related but different categories of offerings can cause a problem with purchaser accounting, particularly when the purchaser is a big purchaser, because the purchaser cannot see the total cost of purchase of the related offerings in different categories.

To overcome or mitigate the cumbersomeness of different offerings such as products, services, and usage being sold in different locations and with different systems to a purchaser, embodiments described herein allow for a purchaser to purchase different offerings in a common purchase. More particularly, a purchaser may purchase from multiple categories of offerings with a common purchase.

A graphical user interface (not shown) hosted on a computer may allow a purchaser to purchase from multiple categories of offerings such as products, services, and usage with a common purchase spanning the multiple categories of offerings by a business. Thus, a purchaser may purchase from different categories of offerings from a common virtual location. When the common purchase is received by a common purchase system, the common purchase may be split up into purchase orders based on the common purchase, which each purchase order directed to a specific category of offering. The purchase orders may be directed to the entity providing the offerings and the entity providing the offerings may provide the offerings to the purchaser.

A graphical user interface hosted on a computer and allowing purchases by a purchaser may allow a purchaser to purchase goods into a virtual shopping cart, euphemistically referred to as a cart. In accordance with embodiments described herein, the graphical user interface allows a purchaser to purchase from multiple categories of offerings such as products, services, and usage with a common purchase that is virtually manifested as the cart. Thus, the cart may include multiple categories of purchased offerings provided by different entities. And these entities may be entities of a business. The common purchase system may parse the cart and separate the purchased offerings into respective categories, and then send the purchased offering to the respective entity providing the category of offerings. The respective entity may then provide the purchased offering to the purchaser in accordance with the common purchase made by the purchaser. Thus, the purchaser may receive the entire complement of purchased offerings from the common purchase and from the different providing entities.

Furthermore, billing the purchaser may be effected by the providing entity. Entities providing products may bill the purchaser a one-time payment for the products, or payment may be spaced according to agreement between purchaser and the entity. Entities providing services, or usage may bill the purchaser according to the purchased service or purchased usage. A respective entity may send a purchaser an upfront bill for products or services such as subscription services. An entity may send bills to a purchaser at intervals for usage.

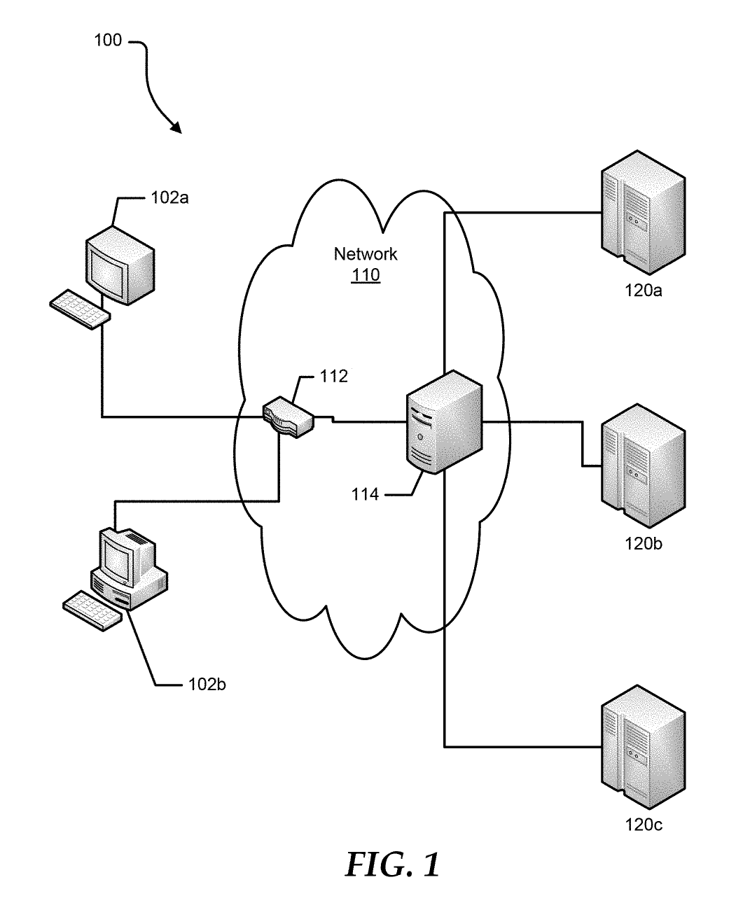

FIG. 1 illustrates an information handling system 100 that allows for purchase of different categories of offerings from a common virtual location. For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

A network 110 connects purchaser computers 102a and 102b with entity computers 120a, 120b, and 120c. More particularly, network 110 includes numerous network devices, such as router 112 and server 114. End-user computers 102a and 102b are connected to router 112 via network 110. End-user computers 102a or 102b may be used by a purchaser and may provide a graphical user interface to the purchaser which allows for purchases of two or more offerings in different categories, thus allowing for purchase of offering in different categories in a single virtual location by a purchaser. The offerings in different categories may be related, such as products, services associated with the products, and usage associated with the products. In a specific example, the products may be computers and computer peripherals, the services may be IT services and analytics associated with the computers, and the usage may be cloud storage provided to the computers.

Server 114 may be associated with or controlled by a business. The business may include entities associated with, for example in control of, entity computers 120a, 120b, and 120c. Entity computers 120a, 120b, and 120c may be on the premises of the respective entities, or may be leased by the respective entities, or otherwise may be associated with and controlled by the respective entity. Each respective entity associated with entity computers 120a, 120b, and 120c may provide category of offering, such as one of products, services, or usage. In a specific example, the business may be Dell Inc. and the entities may be business arms of Dell Inc. One of the business arm entities may sell Dell personal computers and device peripherals, one of the business arm entities may sell information technology (IT) services for Dell computers, and one of the business arm entities may sell cloud computing services to Dell customers.

When a purchaser at computers 102a or 102b purchases offerings in two or more different categories of offerings at the common virtual location provided by computer 102a or 102b, the purchased offerings are saved to a common cart with a common price associated therewith that is provided to the purchaser. Thus, the purchaser may know with one cart the total cost of purchased products, associated purchased services, and purchased usages. The purchase spanning two or more different categories of offerings may be sent from purchaser computers 102a and 102b to router 112 via a connection to network 110. Router 112 in turn may forward the purchase spanning two or more different categories of offerings to server 114. Server 114 may split the purchased offerings in the common cart into the different categories of offerings, and forward on the purchased offerings to the entity computers 120a, 120b, and 120c based on the purchased category of offering. Entity computers 120a, 120b, and 120c then process the respective purchased offering and the associated entity provides the purchase to the purchaser. Thus, a common purchase spanning offerings in two or more different categories of offerings may be processed by different entities and the purchased offerings provided to the purchaser.

Building upon the example provided above, server 114 may be controlled by Dell Inc., and different Dell business entities may be in control of entity computers 120a, 120b, and 120c. For example, a Dell subsidiary selling products may be in control of entity computer 120a; a Dell IT services subsidiary may be in control of entity computer 120b; and a Dell cloud computing subsidiary may be in control of entity computer 120c. Thus, each of entity computers 120a, 120b, and 120c may be associated with different business entities associated with a business, each different business entity offering offerings in a respective category.

Depending on the specific offerings such as products, services, and usage, a purchasing system in accordance with embodiments may maintain an account associated with a purchaser to allow the purchaser to purchase offerings with the account. The account may include purchasing information associated with a purchaser such as credit card information. If a purchaser desires to purchase services such as IT services, or usage such as cloud storage, the purchasing system may require maintenance of credit card information for billing. Also, the purchasing system may disallow purchasing services or usage if a would-be purchaser does not have an account, or the account does not have credit card information or other payment information allowing for recurring billing.

In embodiments described herein, splitting the purchased offerings in the common cart into the different categories of offerings may be implemented with or in an application programming interface which may receive the common purchase and obtain usage data and pricing associated with the common purchase if the common purchase includes purchased usage. Embodiments discussed above may be implemented in software or in an application specific integrated circuit.

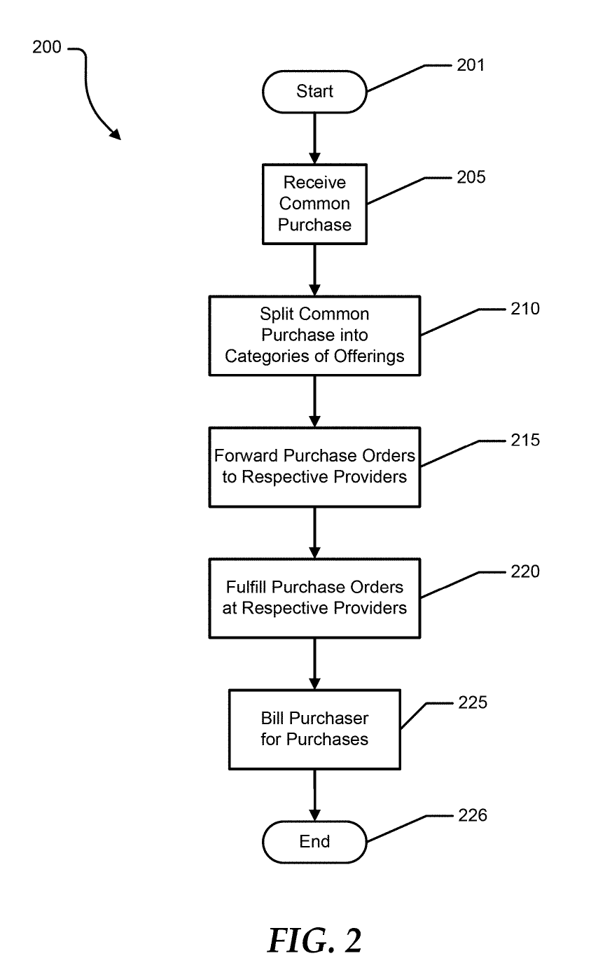

FIG. 2 shows a method 100 for purchasing offerings in different categories. At 201, the method begins. At 205, a purchasing system receives a common purchase spanning multiple categories of offerings, such as products, services, and usage. The purchasing system may provide an interface for a purchaser to purchase offerings in multiple categories. At 210, the common purchase spanning multiple categories of offerings is split into respective categories of offerings, such that there are two or more purchase orders, each purchase order drawn to one category of offering in accordance with the common purchase by the purchaser. Step 210 may be performed by the purchasing system, and parsing logic programmed therein. At 215, the purchase orders are forwarded to respective providers, for example, the providing entity providing the offering specified in the purchase order. Step 215 may be performed by the purchasing system.

At 220, the respective providing entities fulfill the purchase orders, for example, providing the purchased product, service, or usage in accordance with the purchase order. At 225, the purchaser is billed for purchases. For example, step 225 may be performed by the respective providing entities, may be performed by the purchasing system in accordance with the received common purchase, or may be performed by both the purchasing system and the providing entities in conjunction. At 226, the method ends.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. Accordingly, the disclosure is considered to include any one or more of a computer-readable medium or a distribution medium and other equivalents and successor media, in which data or instructions may be stored.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A purchasing system comprising a network computer in communication with a first purchaser computer over a network, the purchasing system configured to:
receive a common purchase spanning a first purchase of a first offer in a first category of offering and a second purchase in a second category of offering from the first purchaser computer, wherein the first category of offering is a different category of offering from the second category of offering;
split the common purchase into a first and a second purchase order, the first purchase order including the first purchase and the second purchase order including the second purchase; and
forward the first purchase order to a first entity computer of a first entity providing the first category of offering, and forward the second purchase order to a second entity computer of a second entity providing the second category of offering, wherein the first entity computer is distinct from the second entity computer.

2. The purchasing system of claim 1, further comprising fulfillment of the first purchase order by a first entity in control of the first entity computer and fulfillment of the second purchase order by a second entity in control of the second entity computer.

3. The purchasing system of claim 2, wherein the first and second entities are entities of a business organization.

4. The purchasing system of claim 1, wherein the first purchase order excludes categories of offerings different from the first category of offering and the second purchase order excludes categories of offerings different from the second category of offering.

5. The purchasing system of claim 1, wherein the first category of offering includes one category of products, services, or usage.

6. The purchasing system of claim 5, wherein the category of products includes computing devices, the category of services includes information technology services for the computing devices, and the category of usage includes cloud usage for the computing devices.

7. The purchasing system of claim 1, wherein the network computer provides a cost bill to the first purchaser computer over the network.

8. The purchasing system of claim 1, wherein the first entity computer bills a purchaser associated with the common purchase for the first purchase order.

9. The purchasing system of claim 1, wherein the first entity computer forwards a cost bill to the first purchaser computer over the network.

10. The purchasing system of claim 1, further comprising parsing logic to forward the second purchase order to the second entity computer over the network.

11. The purchasing system of claim 10, wherein the network computer hosts the parsing logic.

12. The purchasing system of claim 10, wherein the parsing logic splits the common purchase into the first and second purchase orders.

13. The purchasing system of claim 1, wherein the network computer hosts a purchasing interface provided to the first purchaser computer.

14. The purchasing system of claim 13, wherein the purchasing interface provides a cost of the common purchase to the first purchaser computer.

15. The purchasing system of claim 1, further comprising billing logic configured to determine a common cost corresponding to the common purchase based upon the common purchase.

16. The purchasing system of claim 15, wherein the network computer comprises the billing logic.

17. A purchasing system comprising a network computer in communication with a first purchaser computer over a network, the purchasing system comprising parsing logic and configured to:
receive a common purchase spanning a first purchase of a first offer in a first category of offering and a second purchase in a second category of offering from the first purchaser computer at the network computer, wherein the first category of offering is a different category of offering from the second category of offering;
provide the common purchase to the parsing logic, wherein the parsing logic is configured to split the common purchase into a first and a second purchase order, the first purchase order including the first purchase and the second purchase order including the second purchase; and
forward the first purchase order to a first entity computer of a first entity providing the first category of offering and forwarding the second purchase order to a second entity computer of a second entity providing the second category of offering over the network, wherein the first entity computer is distinct from the second entity computer.

18. The purchasing system of claim 17, further comprising fulfillment of the first purchase order by a first entity in control of the first entity computer and fulfillment of the second purchase order by a second entity in control of the second entity computer.

19. A purchasing system comprising a network computer in communication with a first purchaser computer over a network, the purchasing system comprising parsing logic and billing logic, and configured to:
receive a common purchase spanning a first purchase of a first offer in a first category of offering and a second purchase in a second category of offering from the first purchaser computer at the network computer, wherein the first category of offering is a different category of offering from the second category of offering;
provide the common purchase to the parsing logic, wherein the parsing logic is configured to split the common purchase into a first and a second purchase order, the first purchase order including the first purchase and the second purchase order including the second purchase;
forward the first purchase order to a first entity computer of a first entity providing the first category of offering and forwarding the second purchase order to a second entity computer of a second entity providing the second category of offering over the network, wherein the first entity computer is distinct from the second entity computer;
provide the common purchase to the billing logic, wherein the billing logic is configured to determine a common cost based on the common purchase; and
provide the common cost to the first purchaser computer.

20. The purchasing system of claim 19, wherein the billing logic determines a first purchase order cost of the first purchase order and a second purchase order cost of the second purchase order.
